(19) United States
(12) Patent Application Publication
(10) Pub. No.: US 2017/0031302 A1
(43) Pub. Date: Feb. 2, 2017

(54) BIASED MEMBER TO PREVENT CONTAMINATION

(71) Applicant: Eastman Kodak Company, Rochester, NY (US)

(72) Inventors: Mark Cameron Zaretsky, Rochester, NY (US); Richard George Allen, Rochester, NY (US); Robert David Bobo, Ontario, NY (US); Michael Thomas Dobbertin, Honeoye, NY (US)

(21) Appl. No.: 14/814,561

(22) Filed: Jul. 31, 2015

(51) Int. Cl. B41J 2/385

(52) U.S. Cl. CPC G03G 21/06; G03G 15/04036

(57) ABSTRACT

A method for preventing contamination of a lens assembly by charged particles on an image bearing surface in an electrophotographic printer includes providing a conductive electrode with an opening adjacent the lens assembly; charging the conductive electrode with a variable voltage power supply; and matching a voltage on the image bearing surface with the variable voltage power supply.

### FIELD OF THE INVENTION

The present invention relates in general to electrophotographic printing and in particular to preventing contamination of a lens assembly.

### BACKGROUND OF THE INVENTION

Printers are useful for producing printed images of a wide range of types. Printers print on receivers (or “imaging substrates”), such as pieces or sheets of paper or other planar media, glass, fabric, metal, or other objects. Printers typically operate using subtractive color: a substantially reflective receiver is overcoated image-wise with cyan (C), magenta (M), yellow (Y), black (K), and other colorants. Various schemes can be used to process images to be printed. Printers can operate by inkjet, electrophotography, and other processes.

In the electrophotographic (EP) process, an electrostatic latent image is formed on a photoreceptor by uniformly charging the photoreceptor using a primary charger, e.g. corona or roller charger, and then optically discharging selected areas of the uniform charge to yield an electrostatic charge pattern corresponding to the desired image (a “latent image”). After the latent image is formed, charged toner particles are brought into the vicinity of the photoreceptor and are attracted to the latent image to develop the latent image into a visible image. Note that the visible image may not be visible to the naked eye depending on the composition of the toner particles, e.g., clear toner.

After the latent image is developed into a visible image on the photoreceptor, a suitable receiver is brought into juxtaposition with the visible image. A suitable electric field is applied to transfer the toner particles of the visible image to the receiver to form the desired print image on the receiver. The receiver is then removed from its operative association with the photoreceptor and subjected to heat or pressure to permanently fix (“fuse”) the print image to the receiver. Plural print images, e.g., of separations of different colors, are overlaid on one receiver before fusing to form a multi-color print image on the receiver.

The electrostatic transfer of the charged toner particles is rarely 100%, residual toner left on the photoreceptor can be as much as 10% of the developed image. This necessitates a cleaning step where a blade or brush mechanism mechanically removes the residual toner from the photoreceptor surface. However, this step may also not be 100% effective and small amounts of charged toner particles will remain on the photoreceptor as the photoreceptor cycles back to the beginning of another imaging sequence. As the residual toner on the photoreceptor passes under the primary charger it will accumulate more charge. See FIG. 2, reference 45. Therefore, this charged toner will be more likely to contaminate surfaces near the photoreceptor under the influence of an electrostatic attractive force generated between that surface and the photoreceptor.

One such area of concern for toner contamination is an LED printhead housing and lens located just after the primary charger and used to create the latent image. The housing is connected to electrical ground to create an electrostatic shield and minimize the electromagnetic interference (EMI) created by the printhead electronics. However, this grounded housing also creates a strong electric field that electrostatically attracts residual toner on the photoreceptor. See FIG. 2, references 46A and 46B. Residual toner attracted to the housing can end up contaminating the surface of the insulating lens located within an opening of the housing. This toner reduces the exposure efficiency of the printhead and, more importantly, creates a non-uniformity in the exposure that is difficult to compensate, resulting in objectionable artifacts in the print quality.

U.S. Pat. No. 5,911,093 (Ohsawa) presents the problem of contamination of a corotron charger housing by residual toner on the photoreceptor as the photoreceptor passes by the corotron charger for the uniform charging of the photoreceptor process step. The contamination is prevented by applying a bias to the normally grounded charger housing. However, this solution has some drawbacks. It is well known that biasing the shell of a corotron charger effects the output of the charger. Also, biasing the charger shell can prevent contamination only because the shell itself is a conductor. The solution presented in U.S. Pat. No. 5,911,093 would not be feasible, for example, with a lens assembly made of an insulating glass or transparent plastic material.

U.S. Pat. No. 4,697,914 (Hauser) discloses an electrode mounted on the housing of a development apparatus adjacent to an opening through which toner contained in the development station may escape and contaminate the photoreceptor due to a combination of aerodynamic and electrostatic forces. This electrode is electrically biased at a constant voltage, creating an electric field that prevents the toner from escaping through the opening, causing the toner to remain in the development station and not contaminate non-image areas of the photoreceptor. One or more constant voltage power supplies are added to provide this function.

It is possible to use air flow to prevent contamination of the housing and lens. However this solution has significant drawbacks such as added cost, higher acoustic noise, and design complexity, particularly for retrofitting into existing printers at customer sites. It is, therefore, desirable to provide a solution to the lens contamination problem that minimizes cost and design complexity.

### SUMMARY OF THE INVENTION

According to one embodiment of the present invention a method for preventing contamination of a lens assembly by charged particles on an image bearing surface in an electrophotographic printer includes providing a conductive electrode with an opening adjacent the lens assembly; charging the conductive electrode with a variable voltage power supply; and matching a voltage on the image bearing surface with the variable voltage power supply.

The electrostatic attractive force may be minimized in one of two ways: a) for new printers the housing is not grounded but connected to the grid supply for the primary charger (FIG. 3), b) for existing printers in the field a part is attached to the existing grounded housing—the part has a conductive electrode not contacting the housing and electrically connected to the grid supply for the primary charger (FIG. 4). The surface potential of the photoreceptor is typically within 100V of the grid voltage so the electric field between a part connected to the grid supply and the photoreceptor surface is too small to provide a significant attractive force on the residual toner remaining on the photoreceptor surface, thereby keeping the housing and printhead lens free of toner contamination. The photoreceptor surface potential is part of the color process control system, and may vary between −250 and −850 volts. The grid voltage tracks this within 100 volts such that when the grid bias is connected to the housing the attractive field is low over the full range of process control.

For the creation of the latent image, the printhead lens must be transparent so as to allow efficient transmission of light to the photoreceptor over a wide dynamic range. Adding a transparent biased electrode in the optical path of the lens would add significant cost. As a low cost alternative, the housing may be modified as described above and will have a geometry such that the bias electrode forms a slot in the plane of the lens or in a plane between the lens and the photoreceptor. Ideally the width of the slot has a similar dimension or smaller than the separation between the electrode and the photoreceptor. If the width of the slot is larger than the separation between the electrode and the photoreceptor, some contamination benefit may still exist though the efficacy of the method will be reduced.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 provides an elevational cross-section showing portions of a typical electrophotographic printer.

FIG. 2 provides a close up view of the electrophotographic subsystems that are most relevant to this invention with the writer housing grounded.

FIG. 3 provides a close up view of the electrophotographic subsystems that are most relevant to this invention with the writer housing electrically connected to the primary charger grid power supply.

FIG. 4 provides a close up view of the electrophotographic subsystems that are most relevant to this invention with an isolated electrode structure attached to the grounded writer housing electrically and electrically connected to the primary charger grid power supply.

FIG. 5a shows a top view of a dielectric layer in the isolated electrode structure;

FIG. 5b shows one embodiment of an electrode placed on top of the dielectric layer shown in FIG. 5a;

FIG. 5c shows another embodiment of a pair of electrodes placed on top of the dielectric layer shown in FIG. 5a.

FIG. 6 shows a perspective view of the isolated electrode structure attached to the grounded writer housing.

FIG. 7 shows a cut away perspective view of the isolated electrode structure attached to the grounded writer housing.

### DETAILED DESCRIPTION OF THE INVENTION

The invention has been described in detail with particular reference to certain preferred embodiments thereof, but it will be understood that variations and modifications can be effected within the scope of the invention.

The electrophotographic (EP) printing process can be embodied in devices including printers, copiers, scanners, and facsimiles, and analog or digital devices, all of which are referred to herein as “printers.” Electrostatographic printers such as electrophotographic printers that employ toner developed on an electrophotographic receiver can be used, as can ionographic printers and copiers that do not rely upon an electrophotographic receiver. Electrophotography and ionography are types of electrostatography (printing using electrostatic fields), which is a subset of electrography (printing using electric fields).

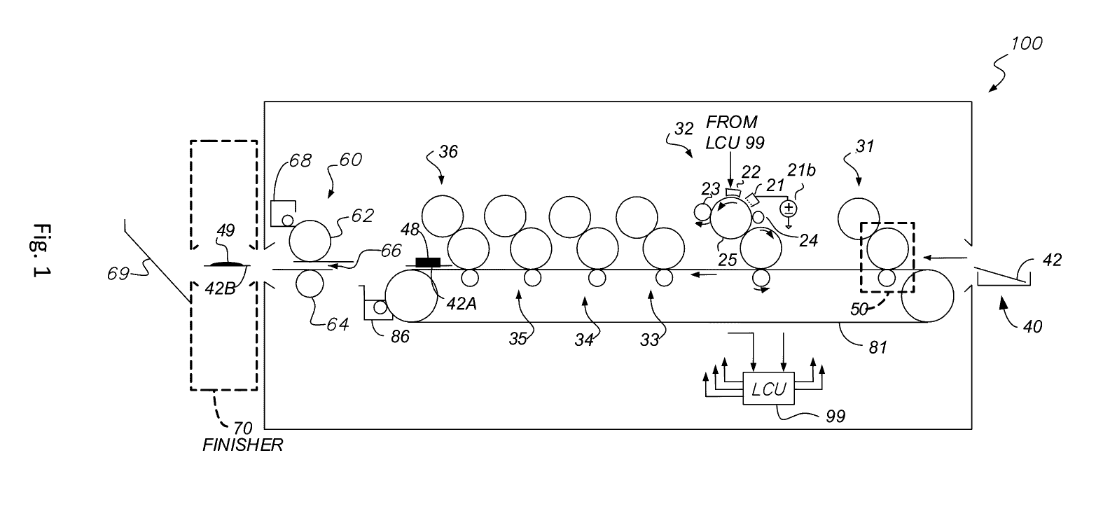

FIG. 1 is an elevational cross-section showing portions of a typical electrophotographic printer 100. Printer 100 is adapted to produce print images, such as single-color (monochrome), CMYK, or hexachrome (six-color) images, on a receiver (multicolor images are also known as “multi-component” images). Images can include text, graphics, photos, and other types of visual content. An embodiment involves printing using an electrophotographic print engine having six sets of single-color image-producing or -printing stations or modules arranged in tandem, but more or fewer than six colors can be combined to form a print image on a given receiver. Other electrophotographic writers or printer apparatus can also be included. Various components of printer 100 are shown as rollers; other configurations are also possible, including belts.

Referring to FIG. 1, printer 100 is an electrophotographic printing apparatus having a number of tandemly-arranged electrophotographic image-forming printing modules 31, 32, 33, 34, 35, 36, also known as electrophotographic imaging subsystems. Each printing module 31, 32, 33, 34, 35, 36 produces a single-color toner image for transfer using a respective transfer subsystem 50 (for clarity, only one is labeled) to a receiver 42 successively moved through the modules. Receiver 42 is transported from supply unit 40, which can include active feeding subsystems as known in the art, into printer 100. In various embodiments, the visible image can be transferred directly from an imaging roller to a receiver 42, or from an imaging roller to one or more transfer roller(s) or belt(s) in sequence in transfer subsystem 50, and thence to receiver 42. Receiver 42 is, for example, a selected section of a web of, or a cut sheet of, planar media such as paper or transparency film.

Each printing module 31, 32, 33, 34, 35, 36 includes various components. For clarity, these are only shown in printing module 32. Around photoreceptor 25 are arranged, ordered by the direction of rotation of photoreceptor 25, primary charger 21, exposure subsystem 22, and toning station 23.

In the EP process, an electrostatic latent image is formed on photoreceptor 25 by uniformly charging photoreceptor 25 and then discharging selected areas of the uniform charge to yield an electrostatic charge pattern corresponding to the desired image (a “latent image”). Primary charger 21 produces a uniform electrostatic charge on photoreceptor 25 or its surface. Exposure subsystem 22 selectively image-wise discharges photoreceptor 25 to produce a latent image. Exposure subsystem 22 can include a laser and raster optical scanner (ROS), one or more LEDs, or a linear LED array.

After the latent image is formed, charged toner particles are brought into the vicinity of photoreceptor 25 by toning station 23 and are attracted to the latent image to develop the latent image into a visible image. Note that the visible image may not be visible to the naked eye depending on the composition of the toner particles (e.g. clear toner). Toning station 23 can also be referred to as a development station. Toner can be applied to either the charged or discharged parts of the latent image.

After the latent image is developed into a visible image on photoreceptor 25, a suitable receiver 42 is brought into juxtaposition with the visible image. In transfer subsystem 50, a suitable electric field is applied to transfer the toner particles of the visible image to receiver 42 to form the desired print image 48 on the receiver, as shown on receiver 42A.

The imaging process is typically repeated many times with reusable photoreceptors 25. To prepare the photoreceptor for reuse after transferring the toner image to the transfer subsystem 50, a cleaning and regeneration subsystem 24 is provided. The cleaning station can include a blade cleaner or a fiber brush cleaner. Regeneration of the photoreceptor can include charging and exposure functions and is optional.

Receiver 42A is then removed from its operative association with photoreceptor 25 and subjected to heat or pressure to permanently fix (“fuse”) print image 48 to receiver 42A. Plural print images, e.g. of separations of different colors, are overlaid on one receiver before fusing to form a multi-color print image 48 on receiver 42A. Receiver 42A is shown after passing through printing module 36. Print image 48 on receiver 42A includes unfused toner particles.

Subsequent to transfer of the respective print images 48, overlaid in registration, one from each of the respective printing modules 31, 32, 33, 34, 35, 36, receiver 42A is advanced to a fuser 60, i.e. a fusing or fixing assembly, to fuse print image 48 to receiver 42A. Transport web 81 transports the print-image-carrying receivers (e.g., 42A) to fuser 60, which fixes the toner particles to the respective receivers 42A by the application of heat and pressure. The receivers 42A are serially de-tacked from transport web 81 to permit them to feed cleanly into fuser 60. Transport web 81 is then reconditioned for reuse at cleaning station 86 by cleaning and neutralizing the charges on the opposed surfaces of the transport web 81. A mechanical cleaning station (not shown) for scraping or vacuuming toner off transport web 81 can also be used independently or with cleaning station 86. The mechanical cleaning station can be disposed along transport web 81 before or after cleaning station 86 in the direction of rotation of transport web 81.

Fuser 60 includes a heated fusing roller 62 and an opposing pressure roller 64 that form a fusing nip 66 therebetween. In an embodiment, fuser 60 also includes a release fluid application substation 68 that applies release fluid, e.g. silicone oil, to fusing roller 62. Alternatively, wax-containing toner can be used without applying release fluid to fusing roller 62. Other embodiments of fusers, both contact and non-contact, can be employed. For example, solvent fixing uses solvents to soften the toner particles so they bond with the receiver 42. Photoflash fusing uses short bursts of high-frequency electromagnetic radiation (e.g. ultraviolet light) to melt the toner. Radiant fixing uses lower-frequency electromagnetic radiation (e.g. infrared light) to more slowly melt the toner. Microwave fixing uses electromagnetic radiation in the microwave range to heat the receivers (primarily), thereby causing the toner particles to melt by heat conduction, so that the toner is fixed to the receiver 42.

The receivers (e.g., receiver 42B) carrying the fused image (e.g., fused image 49) are transported in a series from the fuser 60 along a path either to a remote output tray 69, or back to printing modules 31, 32, 33, 34, 35, 36 to create an image on the backside of the receiver (e.g., receiver 42B), i.e. to form a duplex print. Receivers (e.g., receiver 42B) can also be transported to any suitable output accessory. For example, an auxiliary fuser or glossing assembly can provide a clear-toner overcoat. Printer 100 can also include multiple fusers 60 to support applications such as overprinting, as known in the art.

In various embodiments, between fuser 60 and output tray 69, receiver 42B passes through finisher 70. Finisher 70 performs various media-handling operations, such as folding, stapling, saddle-stitching, collating, and binding.

Printer 100 includes main printer apparatus logic and control unit (LCU) 99, which receives input signals from the various sensors associated with printer 100 and sends control signals to the components of printer 100. LCU 99 can include a microprocessor incorporating suitable look-up tables and control software executable by the LCU 99. It can also include a field-programmable gate array (FPGA), programmable logic device (PLD), microcontroller, or other digital control system. LCU 99 can include memory for storing control software and data. Sensors associated with the fusing assembly provide appropriate signals to the LCU 99. In response to the sensors, the LCU 99 issues command and control signals that adjust the heat or pressure within fusing nip 66 and other operating parameters of fuser 60 for receivers. This permits printer 100 to print on receivers of various thicknesses and surface finishes, such as glossy or matte.

Image data for writing by printer 100 can be processed by a raster image processor (RIP; not shown), which can include a color separation screen generator or generators. The output of the RIP can be stored in frame or line buffers for transmission of the color separation print data to each of respective LED writers, e.g. for black (K), yellow (Y), magenta (M), cyan (C), and red (R), respectively. The RIP or color separation screen generator can be a part of printer 100 or remote therefrom.

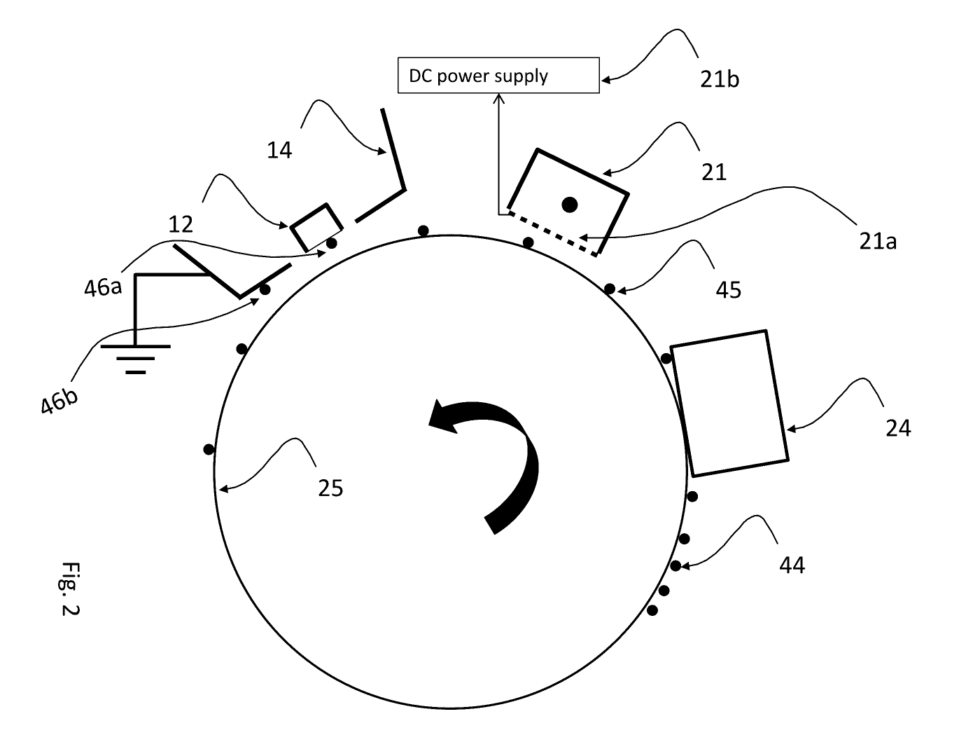

Various parameters of the components of a printing module (e.g., printing module 32) can be selected to control the operation of printer 100. In an embodiment, primary charger 21 is a corona charger including a grid between the corona wires (not shown) and photoreceptor 25. Voltage source 21b applies a voltage to grid 21a (shown in FIG. 2) to control charging of photoreceptor 25. In an embodiment, a voltage bias is applied to toning station 23 to control the electric field, and thus the rate of toner transfer, from toning station 23 to photoreceptor 25. In an embodiment, a voltage is applied to a conductive base layer of photoreceptor 25 before development, that is, before toner is applied to photoreceptor 25 by toning station 23. The applied voltage to the photoreceptor can be zero; the base layer can be grounded. This also provides control over the rate of toner deposition during development. In an embodiment, the exposure applied by exposure subsystem 22 to photoreceptor 25 is controlled by LCU 99 to produce a latent image corresponding to the desired print image. All of these parameters can be changed, as described below.

Further details regarding printer 100 are provided in U.S. Pat. No. 6,608,641 (Alexandrovich et al.) and in U.S. Publication No. 2006/0133870 (Ng et al.), the disclosures of which are incorporated herein by reference.

FIG. 2 provides a close up view of the electrophotographic subsystems that are most relevant to this embodiment of the invention. A photoreceptor 25 passes by a cleaning station 24, removing most but not all of untransferred toner 44. Subsequently, photoreceptor 25 passes under primary charger 21, charging both photoreceptor 25 and residual toner 45. Then photoreceptor 25 passes under LED printhead (with lens) 12 having an electrically grounded housing 14, resulting in the attraction of some residual toner 46a and 46b to both the LED printhead (with lens) 12 and grounded housing 14. This results in diminishing the performance of the LED printhead and negatively impacting the quality of the latent image.

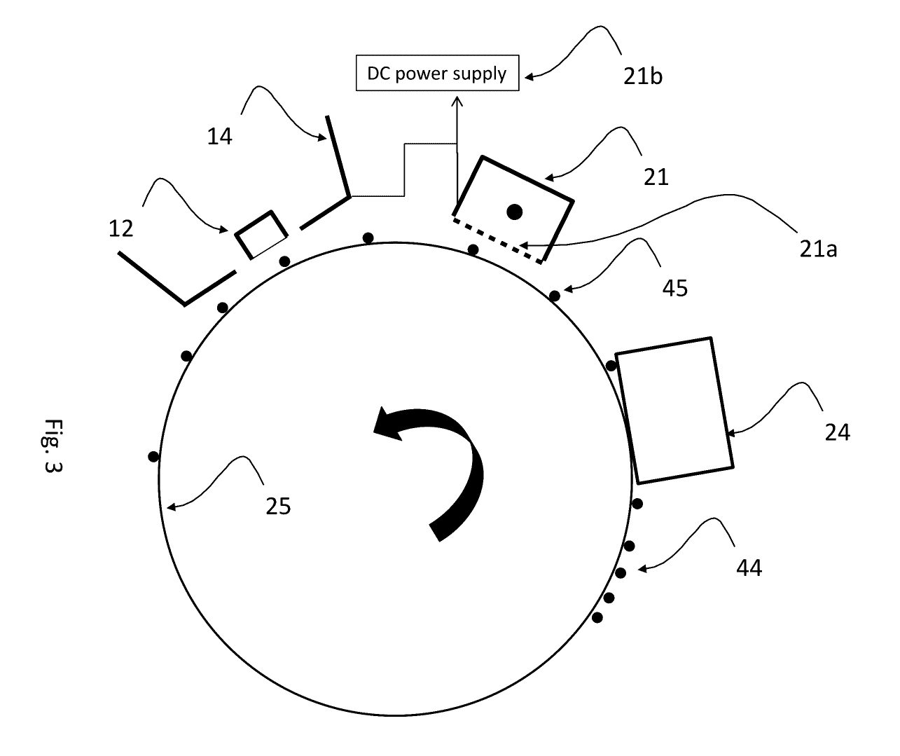

FIG. 3 provides a close up view of the electrophotographic subsystems that are most relevant to this embodiment of the invention with the writer housing electrically connected to the primary charger grid power supply. Similar to the process in FIG. 2, after passing by cleaning station 24 and primary charger 21, the photoreceptor 25 has a charged surface as well as some charged residual toner 45. However, unlike the configuration in FIG. 2, housing 14 is now electrically connected to voltage source 21b, in common with grid 21a. Consequently, residual toner 45 is not attracted to either housing 14 or to LED printhead (with lens) 12 and remains on photoreceptor 25. This embodiment of the invention is suitable for new printers.

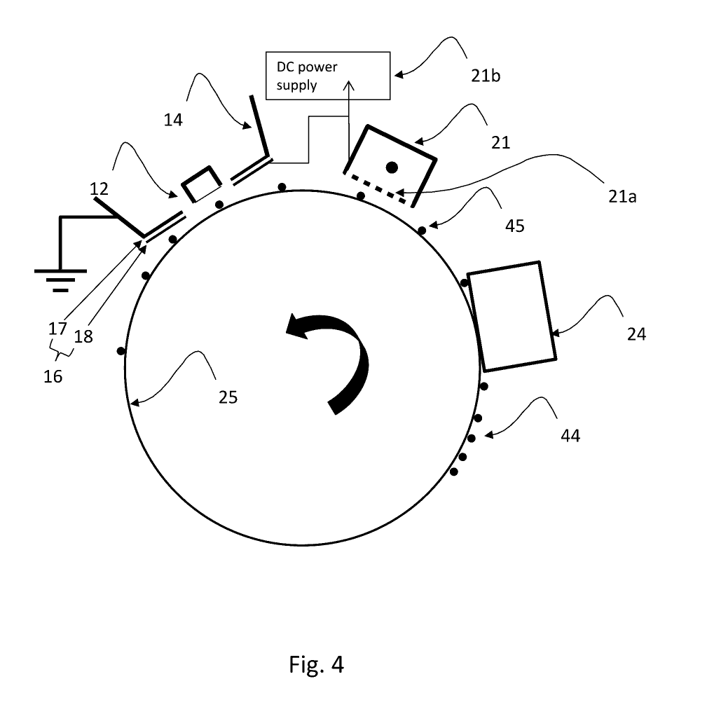

In another embodiment, suitable for retrofitting into existing printers at customer sites, an isolated electrode structure needs to be placed onto the surface of housing 14 or otherwise attached to LED printhead (with lens) 12 so as to cover grounded housing 14 and straddle the printhead lens. FIG. 4 provides a close up view of the electrophotographic subsystems that are most relevant to this embodiment with an isolated electrode structure attached to the grounded writer housing electrically and electrically connected to the primary charger grid power supply. Similar to the process in FIG. 2, after passing by cleaning station 24 and primary charger 21, the photoreceptor 25 has a charged surface as well as some charged residual toner 45. However, unlike the configuration in FIG. 2, housing 14 has an isolated electrode structure 16 covering the surface facing photoreceptor 25. Mounted on dielectric layer 17 is isolated electrode 18 now electrically connected to voltage source 21b, in common with grid 21a. Consequently, residual toner 45 is not attracted to either isolated electrode 18 covering housing 14 or LED printhead (with lens) 12 and remains on photoreceptor 25.

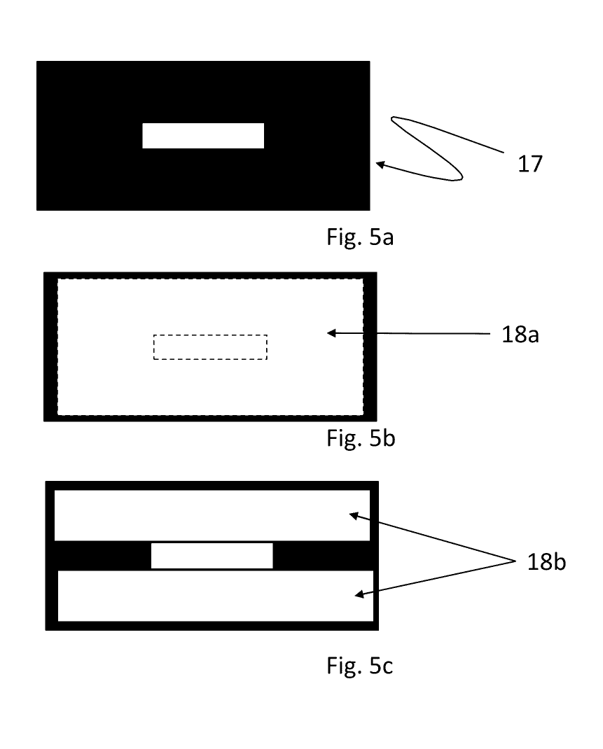

FIG. 5a shows a top view of dielectric layer 17 to be place on top of a grounded housing. FIG. 5b shows one embodiment in which electrode 18 consists of one part (upper) electrode 18a which is placed on top of dielectric layer 16. FIG. 5c shows a second embodiment in which electrode 18 consists of two part (lower) electrodes 18b which are placed on top of the dielectric layer shown in FIG. 5a.

Insulating materials that may be used for dielectric layer 17 include, but are not limited to, plastic films such as polyester terephthalate (PET), polyethylene, Teflon, nylon, acetal, polycarbonate, and Delrin,

Conducting materials that may be used for electrode 18 or upper electrode 18a and lower electrode 18b include, but are not limited to, metals such as steel, copper, nickel, aluminum, or conductive plastics such as carbon loaded epoxies or conductive EPDM.

Methods of affixing isolated electrode structure 16 to housing 14 include, but are not limited to, adhering with a magnet, glue, double-sided tape, or other adhesive, or fastening with clips.

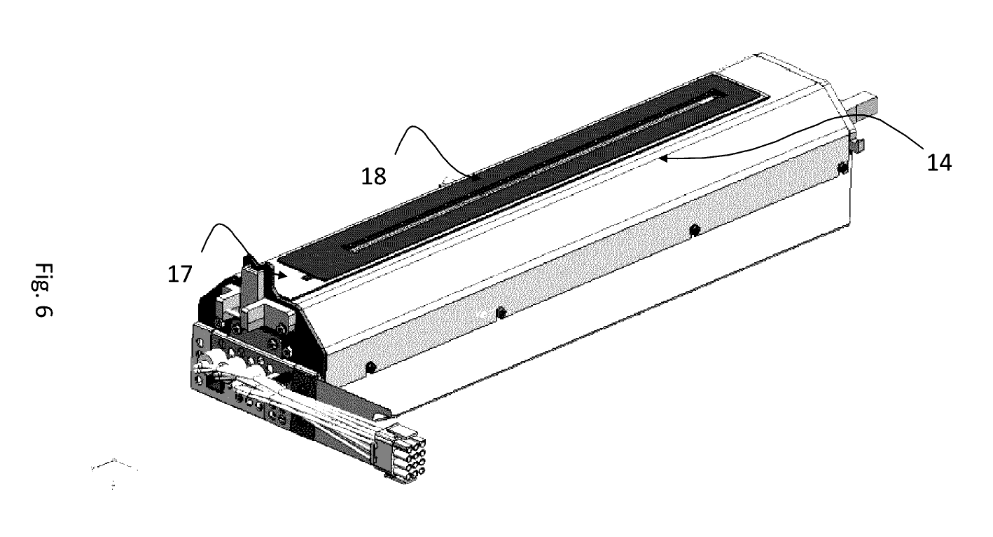

FIG. 6 shows a perspective view of the LED housing with a cutout (shown) for the printhead with a selfoc lens (hidden from view). A dielectric layer 17 and an affixed biased electrode 18 with a cutout for printhead lens is shown. The isolated electrode structure (parts 17 and 18) may clip on to the edge of cutout for original housing.

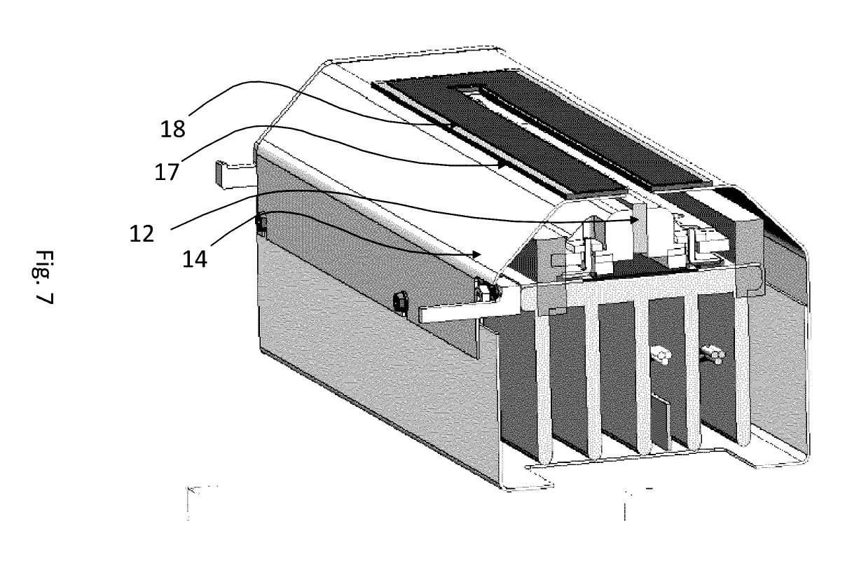

FIG. 7 shows a cut away perspective view of the LED housing with the cutout for the printhead and the LED printhead with a selfoc lens 12 now in view. The dielectric layer 17 and the affixed biased electrode 18 with a cutout for printhead lens is shown relative to the housing 14 of the printhead assembly.

The invention has been described in detail with particular reference to certain preferred embodiments thereof, but it will be understood that variations and modifications can be effected within the scope of the invention.

### PARTS LIST

12 LED printhead (with lens)
14 housing
16 isolated electrode structure
17 dielectric layer
18 isolated electrode
18a one part (upper) electrode
18b two part (lower) electrode
21 primary charger
21a grid
21b voltage source
22 exposure subsystem
23 toning station
24 cleaning station
25 photoreceptor
31 printing module
32 printing module
33 printing module
34 printing module
35 printing module
36 printing module
40 supply unit
42 receiver
42A receiver
42B receiver
44 untransferred toner
45 residual toner
46A residual toner
46B residual toner
48 print image
49 fused image
50 transfer subsystem
60 fuser
62 fusing roller
64 pressure roller
66 fusing nip
68 release fluid application substation
69 output tray
70 finisher
81 transport web
86 cleaning station
99 logic and control unit (LCU)
100 printer

1. A method for preventing contamination of a lens assembly by charged particles on an image bearing surface in an electrophotographic printer comprising:
providing a conductive electrode with an opening adjacent the lens assembly, wherein said conductive electrode is provided upstream and downstream of the lens assembly with respect to a direction of movement of the image bearing surface;
charging the conductive electrode with a variable voltage power supply; and
matching a voltage on the image bearing surface with the variable voltage power supply so as to reduce an attractive force between the image bearing surface and the conductive electrode.

2. The method of claim 1, wherein the conductive electrode is attached to a dielectric layer and the dielectric layer is attached to a housing of the lens assembly.

3. The method of claim 2, wherein the conductive electrode is made of a metallic material.

4. The method of claim 1, wherein the variable voltage power supply is the same power supply used to energize a corona charger grid in the electrophotographic printer.

5. The method of claim 1, wherein the image bearing surface is a photoreceptor used to create a latent image and the surface of the photoreceptor is charged to a voltage level by a corona charger.

6. The method of claim 5, wherein the voltage level of the surface of the photoreceptor matches a voltage level applied to the corona charger grid by a corona charger grid power supply.

7. An exposure subsystem for an electrophotographic printer comprising:
an LED array for forming an image on an image bearing surface;
a lens assembly for focusing the LED array on the image bearing surface;
a conductive electrode with an opening adjacent the lens assembly, wherein said conductive electrode is provided upstream and downstream of the lens assembly with respect to a direction of movement of the image bearing surface;
wherein the conductive electrode is charged with a variable voltage power supply; and
wherein a voltage on the variable voltage power supply matches a voltage on the image bearing surface, so as to reduce an attractive force between the image bearing surface and the conductive electrode.
